(19) United States
(12) Patent Application Publication
(10) Pub. No.: US 2005/0247863 A1
(43) Pub. Date: Nov. 10, 2005

(54) Photoelectric switch for use in sealed cases

(75) Inventor: Michael L. Kaessner, Longmont, CO (US)

Correspondence Address: HUFFMAN LAW GROUP, P.C., 1832 N. CASCADE AVE., COLORADO SPRINGS, CO, 80907-7449, US

(73) Assignee: Susanne Arens, Colorado Springs, CO (US)

(21) Appl. No.: 11/121,883

(22) Filed: May 4, 2005

Related U.S. Application Data
(60) Provisional application No. 60/568,120, filed on May 4, 2004.

(51) Int. Cl. G06M 7/00

(52) U.S. Cl. 250/221

(57) ABSTRACT

A switching apparatus and method are provided for employment in a sealed enclosure. The switching apparatus includes a transparent window, a light-emitting device, and a light-responsive device. The transparent window is a part of an enclosure that is sealed to preclude infiltration of an ambient environment. The transparent window is configured for placement of an object. The light-emitting device is within the enclosure and is disposed closely adjacent to a first point of the transparent window. The light-emitting device emits light through the transparent window into the ambient environment. The light-responsive device is also within the enclosure and is disposed closely adjacent to a second point of the transparent window. The light-responsive device is configured to detect the light. The transparent window allows for transmission of the light. Placement of the object interrupts detection of the light by the light-responsive device.

### CROSS-REFERENCE TO RELATED APPLICATIONS

This application claims the benefit of the U.S. Provisional Application Ser. No. 60/568120 (Docket: SSCD.0101), entitled PHOTOELECTRIC SWITCH FOR USE IN SEALED CASES, filed on May 4, 2004, and which is herein incorporated by reference for all intents and purposes.

### BACKGROUND OF THE INVENTION

1. Field of the Invention

This invention relates in general to the field of switching apparatus and methods, and more particularly to a photoelectric switch apparatus and method for use in a sealed enclosure.

2. Description of the Related Art

Sealed cases or enclosures are often employed to transport and operate electronic circuits within an adverse ambient environment (e.g., high pressure, low pressure, underwater environment, explosive or otherwise hazardous gas, etc.). And due to the adverse ambient environment about a sealed unit, sealed openings provided for switches or other control mechanisms are thereby stressed, often resulting in leaks and resultant malfunction of the electronic circuits positioned therein.

For instance, consider a sealed electronics case for use in an underwater environment. The enclosure may include one or more switches on a control panel that allow for actuation by an operator, but which have been sealed to keep the ambient environment (i.e., water) from infiltrating into the sealed case. Typically, each of the switches is sealed through the use of a sealing device that flexes to enable actuation of the switches, while at the same time retains a seal between the switches and the enclosure. One skilled in the art will appreciate that typical sealing devices include washers, o-rings, gaskets, covered domes, membranes, and the like which are fabricated from materials that are pliable enough to enable physical movement of a switch shaft or other actuation mechanism but that still maintain a seal during actuation. Rubber is but one example of the many types of materials that are employed to accomplish the sealing function.

The present inventor has observed, however, that the very nature of a material that is chosen to provide for flexibility in a sealing device is inherently the cause of failure of a seal, and is furthermore what drives up the cost of providing sealed switches. This is because flexing of the material itself causes an incremental breakdown of the material. And such is the reason that mechanical sealed switches can only be actuated a finite number of times before the seals become hardened, take on a permanent set, or otherwise wear out and must be replaced. Hence, conventional sealed switches exhibit high maintenance costs.

In addition, the present inventor has noted that conventional sealed switches may exhibit weakened seals due to irregularities arising from switch shaft manufacture or from chemicals or abrasive substances that will creep into a seal. Moreover, because sealing materials are pliable, they are more vulnerable to displacement due to a pressure differential between the ambient environment and the inside of a sealed enclosure than harder materials.

In contrast to the use of sealing devices, capacitive switches are presently employed for use in adverse ambient environments. Accordingly, a capacitance detection mechanism is used as a means for detecting placement of a finger on a sealed case. And the present inventor has observed disadvantages to the use of capacitance-sensing switches as well, most notably because often times the differences between the capacitances of, say, a finger, and its ambient environment (e.g., water) are not pronounced enough to allow for distinction therebetween. And moreover, capacitive detection means precludes an operator from wearing gloves or other protective gear.

Fukayama et al. teach such a sealed photoelectric switch in U.S. Pat. No. 4,211,923, where both a light-emitting element and a light-responsive element are housed within two opaque plastic shells ultrasonically welded to each other and a window means of transparent plastic that is ultrasonically welded to the shells. And the present inventor notes, with regard to present-day photoelectric switch techniques, that these types of switches are completely sealed in a static configuration and cannot be readily adapted to mounting or actuation orientations other that that provided for by their static configuration.

Barron, Jr. et al., in U.S. Pat. No. 5,077,467, teaches a photoelectric switching mechanism, but the present inventor has found that it is totally unfit for use in a sealed enclosure and furthermore, that it is of a size and configuration inappropriate to a body word device (e.g., protective gloves).

Accordingly, in view of the above-noted limitations and disadvantages present in the art, the present inventor has noted that it is desirable to provide a photoelectric switch for use in a sealed enclosure that exhibits higher reliability and lower fabrication and maintenance costs than that which has heretofore been provided.

### SUMMARY OF THE INVENTION

The present invention, among other applications, is directed to solving the above-noted problems, and addresses other problems, disadvantages, and limitations of the prior art. In one embodiment, a switching apparatus is provided. The switching apparatus includes a transparent window, a light-emitting device, and a light-responsive device. The transparent window is a part of an enclosure that is sealed to preclude infiltration of an ambient environment. The transparent window is configured for placement of an object. The light-emitting device is within the enclosure and is disposed closely adjacent to a first point of the transparent window. The light-emitting device emits light through the transparent window into the ambient environment. The light-responsive device is also within the enclosure and is disposed closely adjacent to a second point of the transparent window. The light-responsive device is configured to detect the light. The transparent window allows for transmission of the light. Placement of the object interrupts detection of the light by the light-responsive device.

One aspect of the present invention contemplates an apparatus for performing a switching function within a sealed enclosure. The apparatus has a transparent window, a light-emitting device, a light-responsive device, and switching logic. The transparent window is configured as a part of the sealed enclosure, and is configured for placement of an object. The light-emitting device is within the sealed enclosure and is disposed closely adjacent to a first point of the transparent window. The light-emitting device emits light through the transparent window into an ambient environment. The light-responsive device is also within the sealed enclosure and is disposed closely adjacent to a second point of the transparent window. The light-responsive device is configured to detect the light. The switching logic is operatively coupled to the light-responsive device. The switching logic senses detection of the light, and executes a function responsive to interruption of the light by an object.

Another aspect of the present invention comprehends a method for performing a switching function. The method includes providing a transparent window as a part of an enclosure that is sealed to preclude infiltration of an ambient environment; emitting light through the transparent window into the ambient environment from a light-emitting device disposed within the enclosure closely adjacent to a first point of the transparent window, and upon placement of an object, detecting a change in the light by a light-responsive device disposed within the enclosure closely adjacent to a second point of the transparent window.

### BRIEF DESCRIPTION OF THE DRAWINGS

These and other objects, features, and advantages of the present invention will become better understood with regard to the following description, and accompanying drawings where:

FIG. 1 is a diagram illustrating a present-day sealed switch;

FIG. 2 is a diagram depicting an alternative conventional sealed switch;

FIG. 3 is a diagram featuring a plan view of photoelectric switches in a sealed enclosure according to the present invention;

FIG. 4 is a diagram showing an end view of the sealed enclosure of FIG. 3 taken along line C-C;

FIG. 5 is a diagram illustrating a cutaway view of one embodiment of a sealed photoelectric switching apparatus in the enclosure of FIG. 3 taken along line B-B;

FIG. 6 is a diagram illustrating a cutaway view of a convex furrow embodiment of a sealed photoelectric switching apparatus in the enclosure of FIG. 3; and

FIG. 7 is a diagram detailing an alternative embodiment of a sealed photoelectric switching apparatus according to the present invention taken along line B-B of FIG. 3.

### DETAILED DESCRIPTION

The following description is presented to enable one of ordinary skill in the art to make and use the present invention as provided within the context of a particular application and its requirements. Various modifications to the preferred embodiment will, however, be apparent to one skilled in the art, and the general principles defined herein may be applied to other embodiments. Therefore, the present invention is not intended to be limited to the particular embodiments shown and described herein, but is to be accorded the widest scope consistent with the principles and novel features herein disclosed.

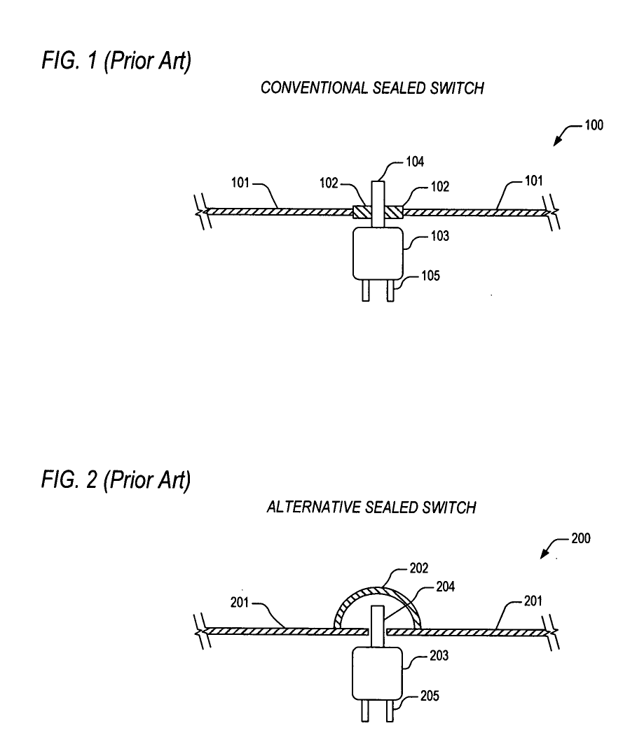

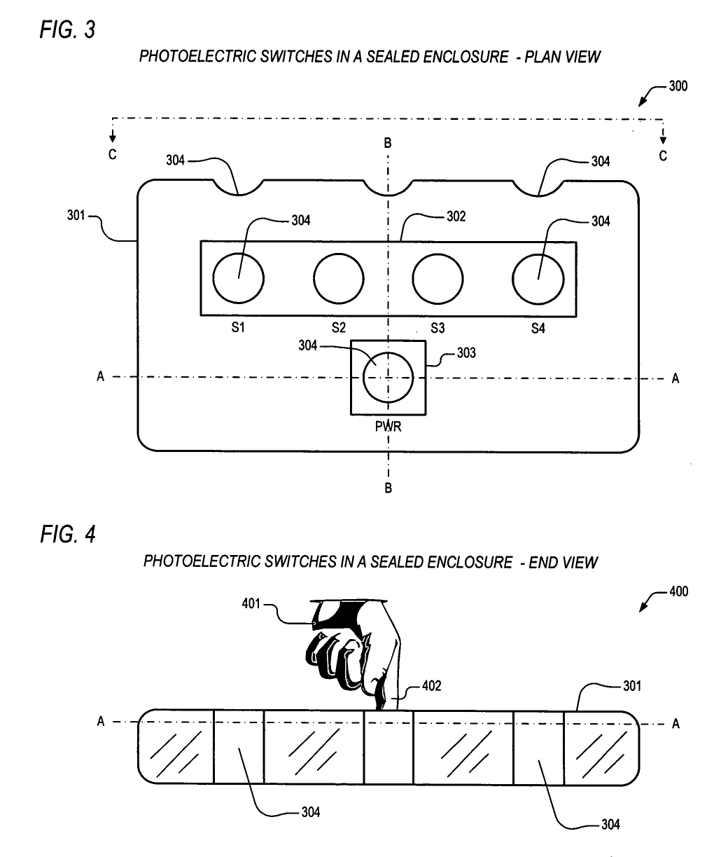

In view of the above background discussion on switches for use either in a sealed environment or in sealed environments, and associated techniques employed to accomplish sealed switching functions, a discussion of the disadvantages and limitations associated with present-day sealed switch techniques will now be presented with reference to FIGS. 1-2. Following this, a discussion of the present invention will be presented with reference to FIGS. 3-6. The present invention provides superior apparatus and methodologies for accomplishing switching functions in a sealed environment that exhibit higher reliability and more cost-effective solutions over that which has heretofore been provided.

Turning to FIG. 1, a cutaway diagram is presented illustrating a present-day sealed switch 100. A conventional switch 103, which includes an actuation shaft 104 and mounting feet 105, is provided within an enclosure 101 and a seal is configured to preclude intrusion of an ambient environment from without the enclosure 101 via use of a sealing device 102 that typically surrounds the shaft 104, but allows the shaft 104 to protrude into the ambient environment (e.g., water, air) for actuation. In many configurations, the mounting feet 105 are also electrical contacts 105 for the switch 103. For clarity purposes, mechanisms that are employed to mount or provide electrical contact to the switch 103 within the enclosure 101 are not shown. The sealing device 102 generally comprises a pressure fitted and treated washer 102, o-ring 102, or like device 102 (e.g., a gasket) that is made from a material (e.g., rubber) that is resistant to the ambient environment, yet which is pliable enough to allow for actuation of the shaft 104 in its intended direction(s) of actuation.

Operationally, when the shaft 104 is actuated, the sealing device 102 must flex to allow for actuation, while simultaneously maintaining a seal between the sealing device 102 and the shaft 104, and between the sealing device 102 and the enclosure 101.

Now referring to FIG. 2, a diagram is presented depicting an alternative conventional sealed switch 200. In the alternative configuration, a conventional switch 203, which includes an actuation shaft 204 and mounting feet 205, is provided within an enclosure 201, and a seal is configured to preclude intrusion of an ambient environment from without the enclosure 201 via employment of a sealing device 202 that typically completely encloses the shaft 204. For clarity purposes, mechanisms that are employed to mount the switch 203 within the enclosure 201 are not shown. In this configuration, the sealing device 202 typically comprises a treated and flexible membrane 202 that is sealed to the enclosure 201. The sealing device 202 is of a material that is resistant to the ambient environment, yet which is pliable enough to allow actuation of the actuation shaft 204 in its intended direction(s) of actuation.

In operation, the sealing device 202 flexes to allow for actuation of the shaft 204 beneath, while simultaneously maintaining a seal between the sealing device 202 and the enclosure 201.

The present inventor has noted that the sealed switch configurations of FIGS. 1-2, and like configurations (e.g., washers, o-rings, gaskets, and equivalent sealing devices) that rely upon a flexible or otherwise pliable material to maintain a seal, suffer from several limitations. First, flexing of the material making up the seal causes an incremental breakdown of the material. Accordingly, the useful life of a sealed switch 100, 200 is often specified in terms of number of actuations. The use of a thin membrane over the shaft 104 is a fragile configuration that can easily incur damage. One skilled in the art will appreciate that, over time, a typical o-ring, gasket, or washer becomes hard and takes a permanent set. Thus, such an approach to providing a sealed switch, albeit effectively operative, is not cost-effective due to a requirement for periodic maintenance to inspect and replace worn seals.

In addition, any irregularity in the shaft-to-enclosure interface will suffer from a weakened seal. Furthermore, dirt, chemicals, or other abrasive substances will incrementally destroy the surface of the material from which the sealing device is constructed, thus degrading the seal. And the sealed switch of FIG. 1 presents two surfaces that can fail: a first surface where the sealing device 102 interfaces to the enclosure 101 and a second surface where the sealing device 102 interfaces to the switch shaft 104.

Moreover, to provide the required flexibility, as noted above, a seal must be manufactured from a pliable material, and pliable materials are, as a matter of course, more vulnerable to displacement due to a pressure differential between the ambient environment and the inside of the enclosure. For example, a typical sealing device will withstand up to a given amount of internal or external force before it begins to displace in its position. Thus, in a low-pressure or vacuum-ambient environment, if the enclosure is filled with inert gas, the sealing device may displace in a direction out of the enclosure thus allowing the inert gas to escape.

Alternatively, in an underwater ambient environment, for example, if a maximum usage depth is exceeded (i.e., maximum ambient pressure), the sealing device may displace in a direction into the enclosure, resulting in the admission of water to the interior, and potentially ruining contents therein. Still further, installation of a switch into a sealed enclosure typically requires that a hole be precisely punched or drilled through the enclosure and that the hole be accurately deburred. If burrs are left in the hole, they can cause the sealing device to fail to seal. Moreover, the operations of punching, drilling, deburring, and installing the sealing device and switch are costly manual operations. And finally, the ambient environment itself can also become corrosive to the sealing material.

As alluded to above, a different technique that is employed in the art to provide for a sealed switching function for operation in an adverse environment is to employ a capacitance detection mechanism as a means for detecting placement of a finger or other object at a designated location on a sealed case. The capacitance detection mechanism is sealed within the case and when an operator alters the capacitance at the designated location, by placing a finger on the surface of the designated location, for example, the detection apparatus therein senses the change in capacitance and interprets this change as input.

The present inventor has observed several disadvantages to the use of capacitance-sensing switches as well. First, in many situations it is extremely difficult to detect the difference in capacitance between a human finger and the surrounding environmental medium, particularly when water is the surrounding ambient medium. This is because water and a human finger exhibit approximately the same capacitance to present-day capacitive detection apparatus. In addition, an operator may be required to wear protective devices in certain environments which will change the capacitance of his/her finger. More specifically, an underwater operator is likely to be wearing gloves, which have a lower capacitance than water, and additionally further displace the operator's finger from the area intended to operate the switch. To compensate, the sealed enclosure has to be thin enough to detect the change in capacitance. Furthermore, in darkened environments, there may be no way of locating the actuating device or prescribed location. In addition, in darkness there may be no means of feedback that the electronic device recognized the operator input.

Yet another technique that is presently employed to provide a sealed switching function for operation in a sealed environment is to employ a sealed photoelectric switch for the switching function. Fukayama et al. teach such a sealed photoelectric switch in U.S. Pat. No. 4,211,923, where both a light emitting element and a light-responsive element are housed within two opaque plastic shells ultrasonically welded to each other and a window means of transparent plastic that is ultrasonically welded to the shells.

With regard to present-day photoelectric switch techniques, such as are disclosed by Fukayama et al., the present inventor has noted problems including switches such as taught by Fukayama are completely sealed in a static configuration and do not lend themselves to varying actuation methods or orientations.

Finally, photoelectric switching mechanisms are also provided for in the art, such as that taught by Barron, Jr. et al. in U.S. Pat. No. 5,077,467, but such switching mechanisms are disclosed solely for use in environments that do not require sealing of the switching mechanism. Barron, Jr. et al. do not contemplate, suggest, or even hint at areas of application where sealing to preclude exposure to an ambient environment would be required, and the techniques taught by Barron, Jr. et al. are significantly vulnerable to intrusion of an ambient environment (e.g., water).

Accordingly, in view of the above-noted limitations and disadvantages present in the art, the present inventor has noted that it is desirable to provide a photoelectric switch for use in a sealed enclosure that exhibits higher reliability and lower fabrication and maintenance costs than that which has heretofore been provided. The present invention provides an apparatus and method that enable an operator to provide inputs to electronic circuits that are positioned inside a sealed case or other like unit without incurring the disadvantageous limitations of present-day sealed input devices such as a sealed switch. Accordingly, embodiments of the present invention comprehend a sealed case or other sealed enclosure that is completely sealed from the adverse ambient environment, that is, there are no holes or other openings in the case to otherwise provide for a mechanical connection between a portion of the switch that an operator actuates and a mechanism within the case that senses actuation by the operator. Similarly, the present invention does not require holes or other types of openings in the case to allow for electrical wires to couple from an actuating device to internal actuation detection mechanisms. A case according to the present invention can thus be employed in a hazardous ambient environment such as an underwater environment or an environment where explosive gases are present—without any danger of leakage. One skilled in the art will appreciate that the integrity of a sealed case is determined by its material and shape. Consequently, a case according to the present invention can be welded by chemical or ultrasonic action to yield even a tighter seal against ambient environments than that which has heretofore been provided. Furthermore, embodiments of the present invention are provided such that light-emitting and light-responsive devices are fabricated on the same circuit card, thus providing cost advantages over the prior art. The present invention will now be discussed with reference to FIGS. 3-6.

Turning now to FIG. 3, a diagram 300 is presented featuring a plan view of photoelectric switches in a sealed enclosure 301 according to the present invention. The diagram 300 shows the enclosure 301, such as a sealed case for underwater use, having transparent windows 302, 303 disposed therein. In one embodiment, the transparent windows 302, 303 are fabricated from the same material as the enclosure 301, thus precluding any need for a seal between the windows 302, 303 and the enclosure 301. An alternative embodiment contemplates, as is more particularly depicted in FIG. 3, fabrication of a single transparent window 302 having a plurality of switch positions 304 disposed therein, where a seal (not shown) is provided between the window 302 and the enclosure 301. A further embodiment comprehends, as also shown in FIG. 3, fabrication of a transparent window 303 having a single switch position 304 disposed therein, where a seal (not shown) is provided between the window 303 and the enclosure 301. Rather than a seal, the present invention also contemplates embodiments where the transparent window 302, 303 is welded to the case 301. According to the present invention, the switch positions 304 are configured to allow for positioning of an actuation object to interrupt or otherwise direct a light beam transmitted from within the enclosure into an ambient medium (e.g., water, oil, high- or low-pressure atmosphere) such that a light-responsive device within the sealed enclosure 301 detects actuation of a corresponding switch.

FIG. 4 is a diagram 400 showing an end view of the sealed enclosure 301 of FIG. 3 taken along line C-C. The diagram 400 illustrates embodiments of the present invention where the transparent window 304 is configured as a receptive shape 304 for placement of an actuation object 402, and where the actuation object 402 is inserted into the receptive shape 304 to actuate a corresponding switch. For illustrative purposes only, the actuation object 402 is shown in the diagram 400 as an index finger 402 on a human hand 401 and is shown being inserted into a receptive shape configured as a receptacle 304 , but the present inventor notes that the present invention contemplates configuration of transparent windows 304 that correspond to other receptive shapes 304 and actuation objects 402 as well to include concave shapes 304 (as shown in both FIGS. 3 and 4) other appendages, covered fingers (e.g., gloved or otherwise protected digits), and actuation tools or keys. Such configurations and actuation objects are subject to application areas of the present invention and ambient environments.

In addition, although FIG. 4 depicts an actuation object 402 inserted into a receptacle 304 for actuating a corresponding switch, it is noted that other configurations of a transparent window 304 are contemplated, as will be further disclosed hereinbelow. And in contrast to present-day techniques for providing a sealed switch, the sealed switch techniques according to a present invention do not rely upon physical movement of an actuation shaft or other part of a switch in order to direct a switching function. Thus, any seal that is employed in embodiments that require such between a transparent window 302 and an enclosure 301 may be configured to effect a permanent seal because no flexing is required. In addition, a receptive shape 304 configured as a concave furrow 304 (shown along edge C-C of FIG. 3) will allow for positive tactile feedback to an operator in a darkened environment where placement of a finger 402 inside of the furrow 304 enhances a gripping mechanism for the enclosure 301 overall.

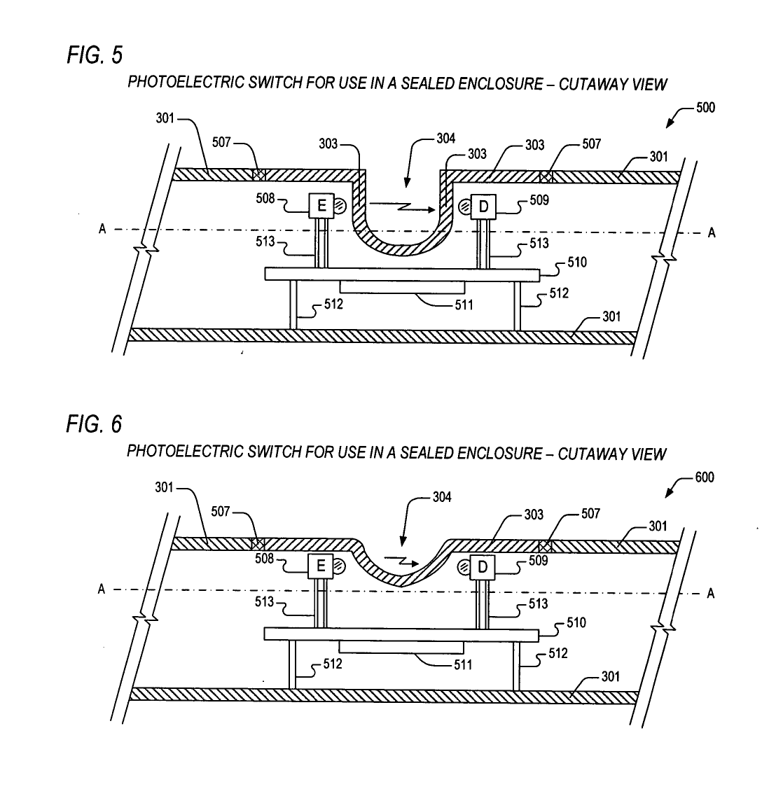

Now referring to FIG. 5, a diagram 500 is presented illustrating a cutaway view of one embodiment of a sealed photoelectric switching apparatus in the enclosure 301 of FIG. 3 taken along line B-B. The diagram 500 depicts a portion of the sealed enclosure 301, to which is coupled a transparent window 303 configured as a receptacle 304. Although the receptacle 304 is depicted as an elongated concave shape configured for insertion of a covered or uncovered finger, as noted above, other shapes for the receptacle 304 are contemplated to correspond to objects that are employed for activation of the switching apparatus. For example, a keyed receptacle 304 would be disposed within the transparent window 303 to provide for activation by a corresponding keyed activation device. Also, in the embodiment shown in FIG. 5, a sealing device 507 is depicted to perfect a seal between the transparent window 303 and the enclosure 301. But, as disclosed above, various embodiments of the present invention contemplate sealed switching apparatus configurations that do not require a sealing device 507 such as configurations where the enclosure 301 and the transparent window 303 are fabricated from the same piece of material. In all embodiments, the transparent window 303 is configured as a part of an enclosure 301 that is sealed to preclude infiltration of an ambient environment, and is furthermore configured for placement of an object (not shown), such as a finger or actuation tool.

The diagram 500 also depicts a light-emitting device 508 within the enclosure 301 that is disposed closely adjacent to a first point of the transparent window 303 such that light from the light-emitting device 508 is emitted through the transparent window 303 into the ambient environment. The present invention contemplates any type of ambient environment to include fluids and gases, and furthermore contemplates pressure differentials between the environment within the enclosure 301 and the ambient environment. The diagram 500 further shows a light-responsive device 509 within the enclosure 301 that is disposed closely adjacent to a second point of the transparent window 303. The light-responsive device 509 is configured to detect the light that is emitted by the light-emitting device 508. The transparent window 303 is fabricated from a material that allows for transmission of the light from the light-emitting device 508 into the ambient environment and back to the light-responsive device 509. Furthermore, the transparent window 303 is configured such that placement of an object interrupts detection of the light by the light-responsive device 509. In the embodiment shown in FIG. 5, the light is sensed by the light-responsive device 509 and when a finger or substantially similar activation object is inserted into the receptacle 304, the light beam is broken, thus interrupting detection. Other embodiments comprehend configurations where the light is transmitted by the light-emitting device 508 and is not detected by the light-responsive device 509 until such time as an actuation object is positioned adjacent to the transparent window 303 such that the light is reflected back through the transparent window 303 into the detection area of the light-responsive device 509.

The light-emitting device 508 and light-responsive device 509 may include one or more mounting mechanisms 513 that allow for mounting to a circuit card assembly 510 or other device 510 that enables orientation of the light-emitting device 508 and the light-responsive device 509 closely adjacent to the first and second points of the transparent window 303. In one embodiment, the light-emitting device 508 and light-responsive device 509 are oriented at opposite sides of the receptacle. The circuit card assembly 510 or other device 510 is affixed to the enclosure 301 via mounting hardware 512. Other embodiments of mounting of the light-emitting device 508, light-responsive device 509, and switching logic 511 are contemplated as well to include affixing such devices 508-509, 511 to the transparent window 303. In the embodiment shown in FIG. 3, the circuit card assembly 510 includes switching logic 511 that is operatively coupled to the light-responsive device 509. The switching logic 511 senses detection of the light by the light-responsive device 509, and is furthermore configured to execute a function. In one embodiment, the function includes executing a switching function such as opening or closing one or more switching paths (not shown). Alternatively, the function may includes performing an operator feedback function. For example, to indicate to an operator that proper activation has occurred, the switching logic 511 could blink the light-emitting device 508. A further function performed by the switching logic comprises a debouncing function, known in the art to preclude false activations. In a more intelligent embodiment, the switching logic 511 comprises a computing device 511 that is configured to execute prescribed portions of one or more application programs upon activation of the switching apparatus.

In one embodiment, the light-emitting device 508 is a light emitting diode provided to emit light at a frequency range within a portion of the electromagnetic spectrum and the light-responsive device 509 is a phototransistor or substantially equivalent photoelectric device 509 that is configured to detect light within that same frequency range. Accordingly, the transparent window 303 is configured to allow for transmission of light at that frequency range. It is noted that the present invention comprehends a portion of the electromagnetic spectrum that includes both ultra-violet and infrared wavelength frequencies. For example, an application area that requires concealment would perhaps employ infrared light and commensurate emitting and sensing devices 508-509.

Now referring to FIG. 6, a diagram 600 is presented illustrating a cutaway view of an alternative embodiment of a sealed photoelectric switching apparatus. The diagram 600 depicts a portion of the sealed enclosure 301, to which is coupled a transparent window 303 configured as a concave furrow 304. The concave furrow 304 is configured for placement of a covered or uncovered finger, although as noted above, other shapes for the concave furrow 304 are contemplated to correspond to objects that are employed for activation of the switching apparatus. One advantage of the embodiment shown in FIG. 6 is that the furrow 304 will accommodate a wide variety of finger sizes to include both covered and uncovered fingers. And substantially similar to the embodiment shown in FIG. 5, a sealing device 507 is depicted to perfect a seal between the transparent window 303 and the enclosure 301. But, as disclosed above, various embodiments of the present invention contemplate sealed switching apparatus configurations that do not require a sealing device 507 such as configurations where the enclosure 301 and the transparent window 303 are fabricated from the same piece of material. In all embodiments, the transparent window 303 is configured as a part of an enclosure 301 that is sealed to preclude infiltration of an ambient environment, and is furthermore configured for placement of an object (not shown), such as a finger or actuation tool.

The remaining elements of the concave furrow embodiment of FIG. 6 are the same as those shown in the embodiment of FIG. 5.

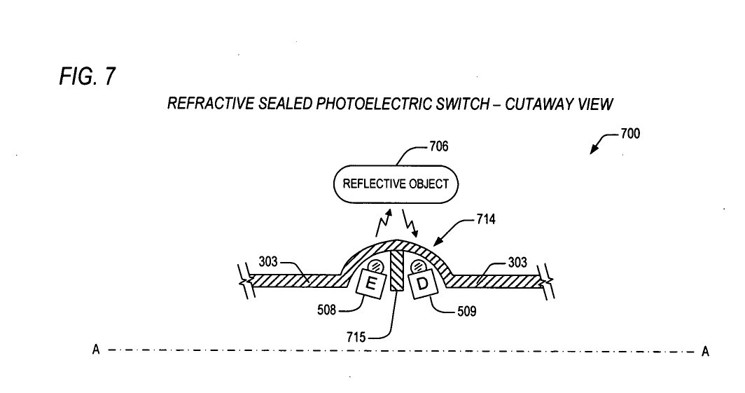

Now referring to FIG. 7, a diagram 700 is presented detailing an alternative embodiment of a sealed photoelectric switch according to the present invention taken along line B-B of FIG. 3. The embodiment of FIG. 7 employs substantially similar elements as described above with reference to FIGS. 5 and 6, but the transparent window 303 is configured as a convex shape 714 to allow for a switching apparatus embodiment where the light is emitted into the ambient environment and activation is accomplished with a reflective activation object 706 which is positioned such that light transmitted by the light-emitting device 508 is reflected back through the transparent window 303 to the light-responsive device 509. In this embodiment, the light-emitting device 508 and light-responsive device 509 are oriented such that the light is optimally reflected and detected when the activation object 706 is placed at an activation position. In such a configuration, the switching logic 511 (not shown in FIG. 7) could perform the function of activation detection when the magnitude of sensed light exceeds a prescribed threshold value. A light blocking device 715 is included in the convex window embodiment to preclude sensing of light by the light-responsive device 509 prior to placement of the reflective object 706. In one embodiment, the reflective object is a finger or substantially similar object, that may be covered or uncovered.

The present invention provides many advantages over that provided for by the prior art. For example, one advantage is that the receptacle embodiment of the transparent window 303 provides for significant tactile feedback to the operator, which is of value in low-light environments. Another advantage of employing an embodiment that is based upon the use of visible light is that the transparent window 303 will absorb some of the transmitted light and will appear to glow, further aiding in identification of the switch location in a darkened environment. Furthermore, if there are any impurities in the ambient environment, they will also reflect the light, thus intensifying the effect. Such an effect is desirable as a safety feature in darkened or underwater environments.

Another advantage of the present invention is that employment of a light emitter and detector to provide for a switching function allows for additional electronics to be mounted on the same circuit as the emitter and detector and furthermore to be sealed within the same case or enclosure without requiring holes, voids, or other openings to provide for switch shafts or electrical wire. Because there are no voids (e.g., holes, seals, etc.) required within a sealed enclosure according to the present invention, it can be fabricated to withstand much greater internal or external pressure than that which has heretofore been provided.

An additional advantage of the present invention is that provided indentations/domes enable an operator to orient his/her fingers, without a requirement for other mechanisms such as switch caps or domes. Also, the employment of electrical transmission and detection devices provides for greater reliability over present-day techniques that employ mechanical devices (e.g., switches, seals, o-rings) which can wear out, decay, harden, or otherwise degrade.

Yet another advantage of the present invention is that the arrangement of the switch elements allows for lower cost of manufacturing by eliminating secondary operations that can cause seal failure and add cost.

Those skilled in the art should appreciate that they can readily use the disclosed conception and specific embodiments as a basis for designing or modifying other structures for carrying out the same purposes of the present invention, and that various changes, substitutions and alterations can be made herein without departing from the spirit and scope of the invention as defined by the appended claims.

1. A switching apparatus, comprising:
a transparent window, configured as a part of an enclosure that is sealed to preclude infiltration of an ambient environment, and configured for placement of an object;
a light-emitting device, within said enclosure and disposed closely adjacent to a first point of said transparent window, for emitting light through said transparent window into said ambient environment; and
a light-responsive device, within said enclosure and disposed closely adjacent to a second point of said transparent window, configured to detect said light;
wherein said transparent window allows for transmission of said light, and wherein placement of said object interrupts detection of said light by said light-responsive device.

2. The switching apparatus as recited in claim 1, wherein said ambient environment comprises a fluid.

3. The switching apparatus as recited in claim 2, wherein said fluid comprises water.

4. The switching apparatus as recited in claim 1, wherein said ambient environment comprises a gas.

5. The switching apparatus as recited in claim 1, wherein said ambient environment is at a different pressure level than contents of said enclosure.

6. The switching apparatus as recited in claim 1, wherein said light comprises a frequency range within a portion of said electromagnetic spectrum, and wherein said portion includes both ultra-violet and infrared wavelengths.

7. The switching apparatus as recited in claim 1, wherein said light-emitting device comprises a light emitting diode (LED).

8. The switching apparatus as recited in claim 1, wherein said light-responsive device comprises a phototransistor.

9. The switching apparatus as recited in claim 1, wherein said transparent window comprises a receptive shape, configured to accept insertion of said object.

10. The switching apparatus as recited in claim 9, wherein said object comprises an appendage, and wherein said receptive shape is configured such that, when said finger is inserted into said receptive shape, detection of said light is interrupted.

11. The switching apparatus as recited in claim 9, wherein said object comprises a covered appendage, and wherein said receptacle is configured such that, when said covered appendage is inserted into said receptive shape, detection of said light is interrupted.

12. The switching apparatus as recited in claim 9, wherein said object comprises an actuation device, and wherein said receptive shape is configured such that, when said actuation device is inserted into said receptive shape, detection of said light is interrupted.

13. The switching apparatus as recited in claim 1, wherein said transparent window comprises a convex window, and wherein placement of said object away from an action position interrupts detection of said light, and wherein placement of said object in said action position causes said light-responsive device to detect said light.

14. The switching apparatus as recited in claim 1, further comprising:
switching logic, operatively coupled to said light-responsive device, configured to sense detection of said light, and configured to execute a function.

15. The switching apparatus as recited in claim 14, wherein said function comprises a switching function.

16. The switching apparatus as recited in claim 1, wherein said function comprises an operator feedback function.

17. The switching apparatus as recited in claim 1, wherein said function comprises a debouncing function.

18. An apparatus for performing a switching function within a sealed enclosure, comprising:
a transparent window, configured as a part of the sealed enclosure, and configured for placement of an object;
a light-emitting device, within the sealed enclosure and disposed closely adjacent to a first point of said transparent window, for emitting light through said transparent window into an ambient environment;
a light-responsive device, within the sealed enclosure and disposed closely adjacent to a second point of said transparent window, configured to detect said light; and
switching logic, operatively coupled to said light-responsive device, configured to sense detection of said light, and configured to execute a function responsive to interruption of said light by an object.

19. The switching apparatus as recited in claim 18, wherein said light-emitting device comprises a light emitting diode (LED).

20. The switching apparatus as recited in claim 18, wherein said light-responsive device comprises a phototransistor.

21. The switching apparatus as recited in claim 18, wherein said transparent window comprises a receptive shape, configured to accept insertion of said object.

22. The switching apparatus as recited in claim 18, wherein said transparent window comprises a convex window, and wherein placement of said object away from an action position interrupts detection of said light, and wherein placement of said object in said action position causes said light-responsive device to detect said light.

23. A method for performing a switching function, comprising:
providing a transparent window as a part of an enclosure that is sealed to preclude infiltration of an ambient environment;
emitting light through the transparent window into the ambient environment from a light-emitting device disposed within the enclosure closely adjacent to a first point of the transparent window, and
upon placement of an object, detecting a change in the light by a light-responsive device disposed within the enclosure closely adjacent to a second point of the transparent window.

24. The method as recited in claim 23, wherein said detecting comprises:
reflecting the light from the object through the ambient environment back through the transparent window.

25. The method as recited in claim 23, wherein said detecting comprises:
interrupting transmission of the light by placement of the object.

26. The method as recited in claim 23, wherein the light-emitting device comprises a light emitting diode (LED).

27. The method as recited in claim 23, wherein the light-responsive device comprises a phototransistor.

28. The method as recited in claim 23, wherein the transparent window comprises a receptive shape, configured to accept insertion of the object.

29. The method as recited in claim 23, wherein the transparent window comprises a convex window.
